(19) United States
(12) Patent Application Publication
(10) Pub. No.: US 2008/0158263 A1
(43) Pub. Date: Jul. 3, 2008

(54) System and method for increasing bit-depth in a display system

(75) Inventors: Sue Hui, Plano, TX (US); Stephen W. Marshall, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/648,346

(22) Filed: Dec. 28, 2006

(51) Int. Cl. G09G 5/10; G09G 3/34

(52) U.S. Cl. 345/690; 345/84

(57) ABSTRACT

In accordance with the teachings of the present disclosure, a system and method for increasing the bit-depth of a video display system using plural spatial light modulators are provided. In one embodiment, the method includes illuminating one or more first spatial light modulators. The method also includes receiving a signal indicating the illumination provided to at least a portion of at least one of the one or more first spatial light modulators should be modified. The method further includes intensity-modulating, by one or more second spatial light modulators in response to the signal, the illumination provided to at least a portion of the at least one of the one or more first spatial light modulators.

### TECHNICAL FIELD

This disclosure relates generally to display systems, and more particularly to a system and method for increasing bit-depth in a video display system using plural spatial light modulators.

### Overview

Spatial light modulators are devices that may be used in a variety of optical communication and/or video display systems. In some applications, spatial light modulators may generate an image by controlling a plurality of individual elements that control light to form the various pixels of the image. One example of a spatial light modulator is a deformable micromirror device (“DMD”), sometimes known as a digital micromirror device.

Typically, spatial light modulators, such as DMDs, operate by pulse width modulation (“PWM”). Generally, the incoming data signal or image is digitized into samples using a predetermined number of bits for each element. This predetermined number of bits is often referred to as the “bit-depth” of the modulator, particularly in systems employing binary bit weights. Generally, the greater the bit-depth, the greater the number of discrete light levels the modulator can display. For spatial light modulators using pulse width modulation, the number of bits assigned to any pixel are always the same for all pixels. The pixel achieves the desired brightness based on the brightness value encoded with the binary or non-binary bits. Thus, the greater the value of the pixel code associated with the pixel, the greater the amount of time the pixel is illuminated during the frame. The most significant bit (“MSB”) is displayed the longest amount of time during the frame, while the least significant bit (“LSB”) is displayed the shortest amount of time during the frame. The size (or duration) of shortest LSB sets the brightness resolution (or bit-depth) that can be achieved for a pixel without using additional dithering technology.

Since greater bit-depth may produce more detailed images, it is often desirable to increase the bit-depth of a video display system. Furthermore, increasing the bit-depth of the display system may reduce spatial contouring artifacts and/or temporal artifacts due to quantization noise. Unfortunately, conventionally the bit-depth of spatial light modulator-based display systems is limited by the minimum size of the LSB, which is in turn limited by the minimum transition time of the individual elements of the spatial light modulator. Conventional methods of increasing the effective bit-depth of video display systems are limited for a variety of reasons.

### SUMMARY

In accordance with the teachings of the present disclosure, a system and method for increasing the bit-depth of a video display system using plural spatial light modulators are provided. In one embodiment, the method includes illuminating one or more first spatial light modulators. The method also includes receiving a signal indicating the illumination level provided to at least a portion of at least one of the one or more first spatial light modulators should be modified. The method further includes intensity-modulating, by one or more second spatial light modulators in response to the signal, the illumination provided to at least a portion of the at least one of the one or more first spatial light modulators.

A technical advantage of some embodiments of the present disclosure includes the ability to increase the bit-depth of a spatial light modulator-based video display system despite the timing limitations typical of some spatial light modulators. In addition, in some embodiments, this increase in bit-depth may be effected using one or more spatial light modulators operable to control nearly the entire range of light intensity of a light output in very fine and fast steps. Furthermore, the ability to reduce the illumination level also improves the contrast ratio of a display system in darker scenes.

Other technical advantages of the present disclosure may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of embodiments of the present disclosure and features and advantages thereof, reference is now made to the following description, taken in conjunction with the accompanying drawings, in which:

FIGS. 1A-1H illustrate example video display systems each having plural spatial light modulators in accordance with various embodiments of the present disclosure;

FIG. 2 illustrates a deformable micromirror device that may be used as one of the plural spatial light modulators of FIGS. 1A-1H in accordance with a particular embodiment of the present disclosure;

FIGS. 3A-3J illustrate example spatial patterns that may be used by some of the spatial light modulators of FIGS. 1A-1H to vary the light intensity provided to a second spatial light modulator; and

FIG. 4 is a chart of light attenuation level versus time applied to a several bit-planes of a portion of the imaging spatial light modulators of FIGS. 1A-1H according to one example embodiment of the present disclosure.

### DETAILED DESCRIPTION OF EXAMPLE EMBODIMENTS

In accordance with the teachings of the present disclosure, a system and method for increasing the bit-depth of a video display system are provided. Generally, particular embodiments of the present disclosure facilitate increasing the number of bits displayed by a first spatial light modulator, such as a deformable micromirror device (“DMD”), sometimes known as a digital micromirror device, by modulating the light output from the light source using a second spatial light modulator. The modulated light output provided to the first spatial light modulator may allow lower significance bits. In this manner, the bit-depth, or the lowest discrete light level a display system may display, is enhanced with an efficient degree of control. Although a particular embodiment is described herein in the context of a DMD, the teachings of the present disclosure are also applicable to other spatial light modulators, and are not limited to deformable micromirror devices.

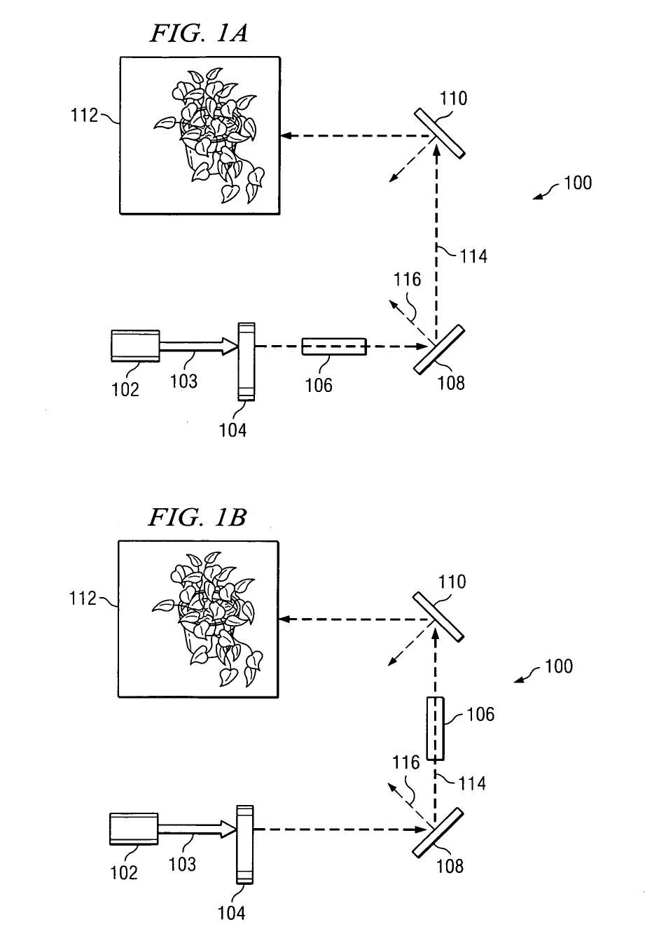

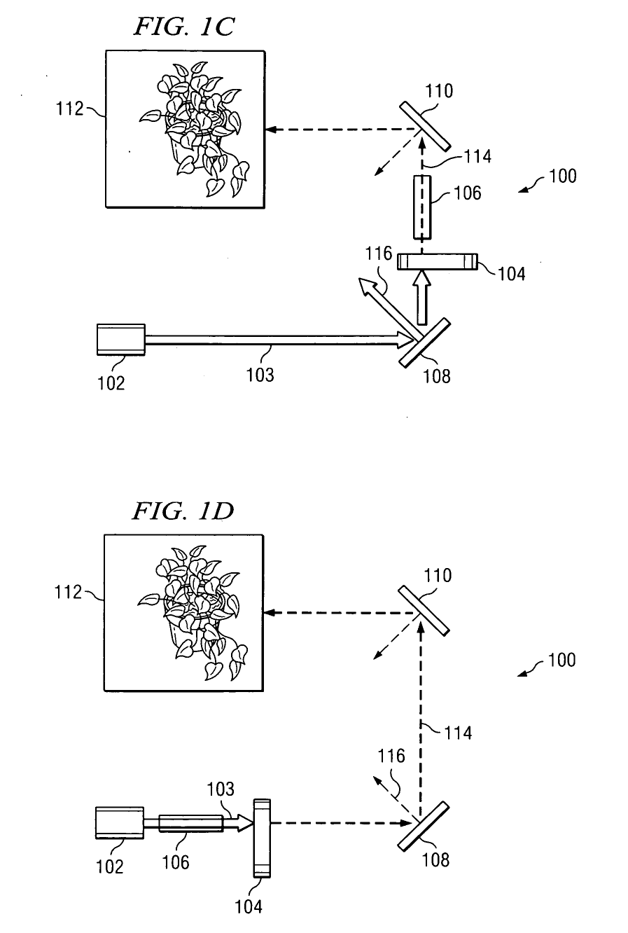

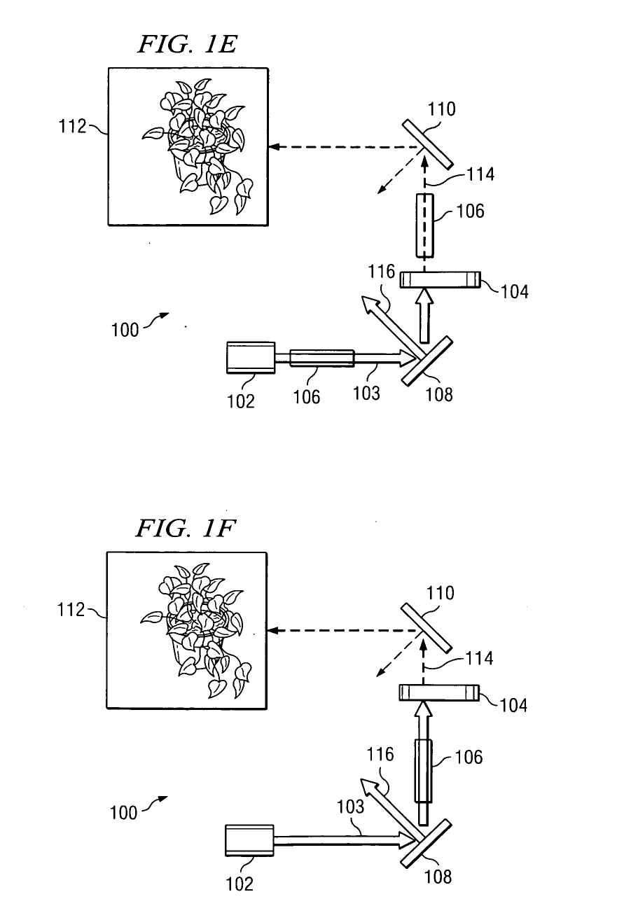

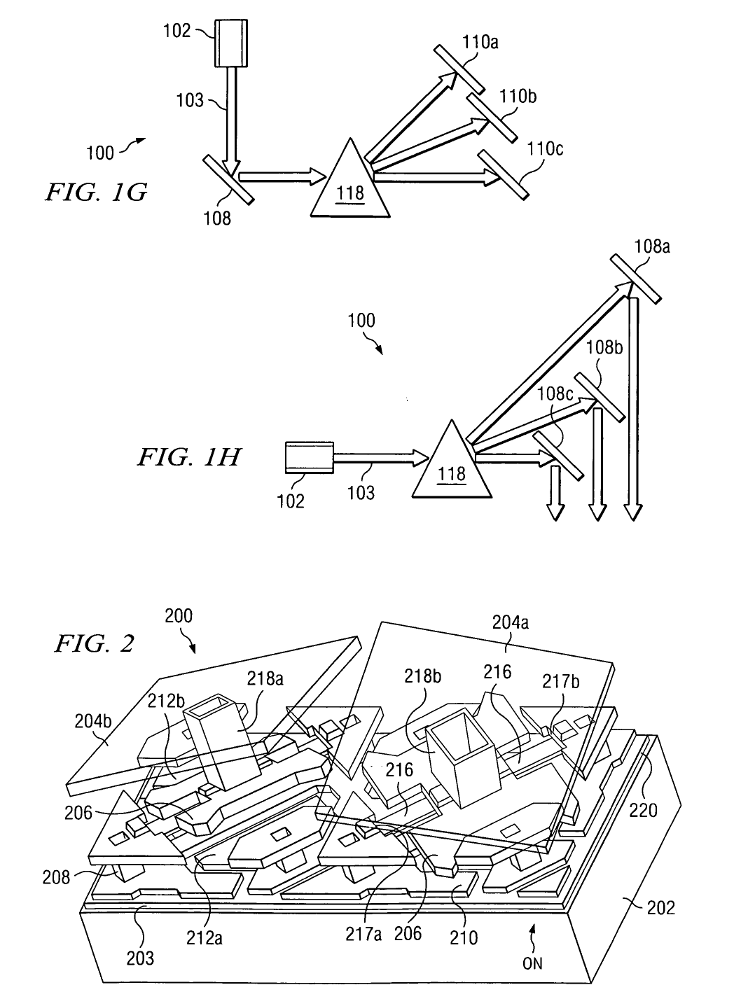

FIG. 1A illustrates a block diagram of one embodiment of a portion of a video display system 100 implementing plural spatial light modulators 108 and 110 to increase the bit-depth of a projected image 112 in accordance with the teachings of the present disclosure. In this example, video display system 100 further includes a light source 102 capable of generating an illumination light beam, a color wheel 104 capable of filtering, or frequency-selecting, the spectrum of the light beam, and an integration rod 106 capable of spatially integrating the light beam. As explained further below, the order of filtering, spatial integration, and intensity modulation of the illumination light beam, performed in the example embodiment by color wheel 104, integration rod 106, and spatial light modulator 108 respectively, is generally interchangeable and other alternative components to these may be utilized. It will be appreciated that system 100 may also include optical components (not explicitly shown), such as, for example, lenses, mirrors and/or prisms operable to perform various functions, such as, for example, filtering, directing, and focusing the light beam.

Light source 102 generally refers to any suitable light source, such as, for example, a metal halide lamp, a xenon arc lamp, an LED, a laser, etc. In the example embodiment, light source 102 includes optics (not explicitly shown) capable of focusing the illumination light beam onto color wheel 104. Color wheel 104 may comprise any device capable of filtering or frequency selecting one of the desired colors (e.g., red, green, blue, yellow, cyan, magenta, white, etc.), in the path of the illumination light beam. Color wheel 104 enables the illumination light beam to be filtered so as to provide “field sequential” images. Color wheel 104 enables system 100 to generate a rapid sequence of single colored images 112 that are perceived by a viewer as natural multi-colored images. Various alternative embodiments may not include a color wheel 102. In some such embodiments, light source 102 may provide colored light using, for example, light emitting diodes or lasers. As explained further below with reference to FIGS. 1G and 1H, in other embodiments a prism 118 may split light from light source 102 into separate colors that may be directed to respective spatial light modulators 108 and/or 110.

In the example embodiment, however, the illumination light beam passes through color wheel 104 before entering integration rod 110. Integration rod 110 generally refers to any device capable of spatially integrating light beams. In the example embodiment, integration rod spatially integrates the illumination light beam by internal reflection. System 100 may also include optics (not explicitly shown) capable of receiving the illumination light beam passing through integration rod 110 and focusing the illumination light beam onto spatial light modulator 108.

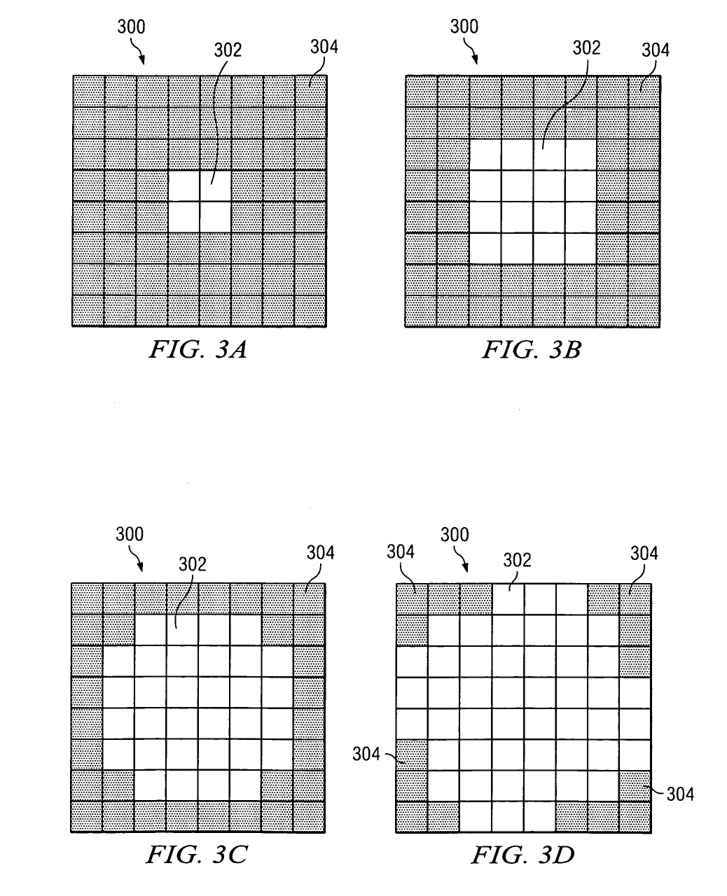

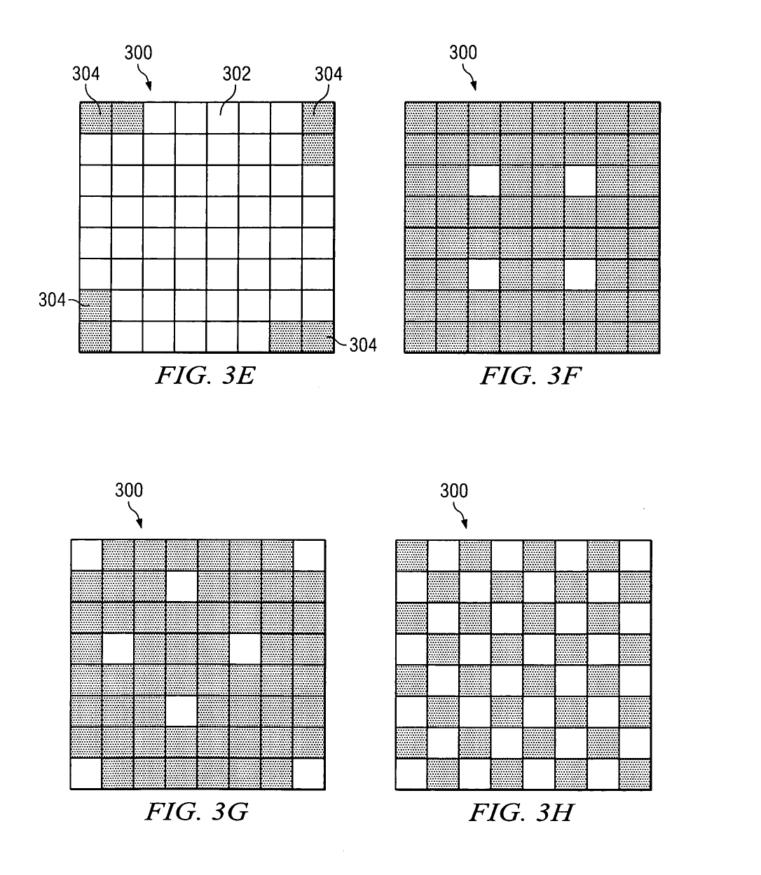

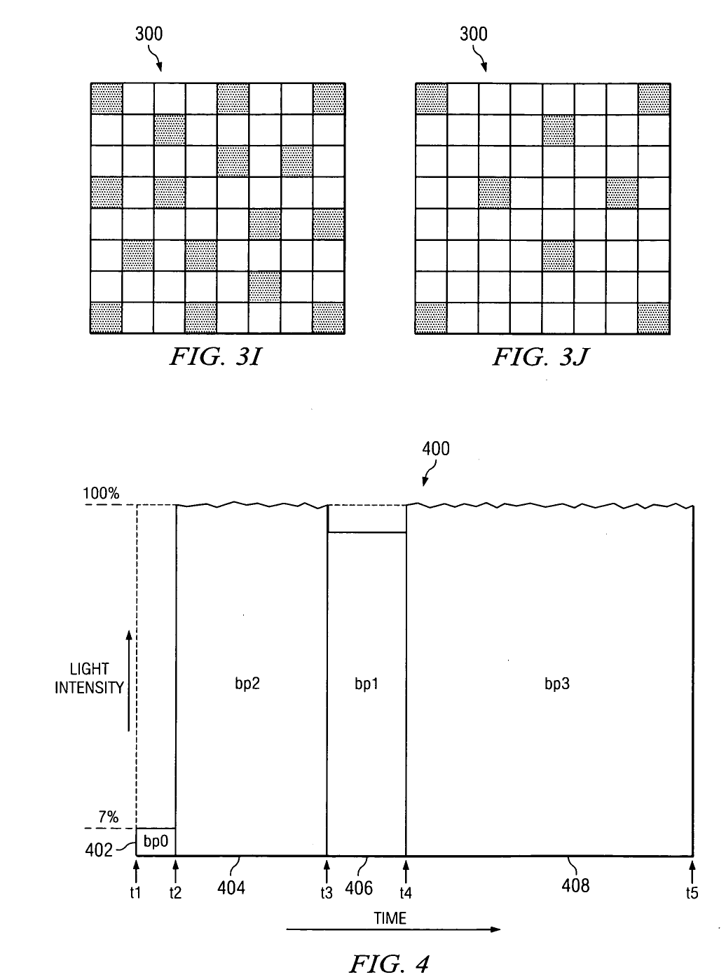

Spatial light modulator 108 generally refers to any device capable of varying the intensity of received light beams in response to an electronic control signal. One of the methods of varying the intensity when using a DMD (digital micromirror device) is based on selectively transmitting part of the received light beam in various patterns, such as, for example, the patterns depicted in FIGS. 3A through 3J. In the example embodiment, spatial light modulator 108 selectively communicates at least some of the illumination light beam along a light path 114. As shown in FIG. 1A, spatial light modulator 108 selectively communicates by selective redirection, such as for example, using reflective liquid crystal on silicon (“LCOS”) technology. However, in various other embodiments spatial light modulator 108 may selectively transmit, absorb or diffract at least some of the illumination light beam. For example, spatial light modulator 108 may comprise a liquid crystal display (“LCD”) or an interferometric modulator. The modulation of suitable spatial light modulators 108 may be either digital or analog. In this particular embodiment, however, spatial light modulator 108 comprises a DMD. A DMD is an electromechanical device comprising an array of hundreds of thousands of tilting mirrors. Each mirror may tilt, for example, plus or minus ten degrees for the active “on” state or “off” state. To permit the mirrors to tilt, each mirror is attached to one or more hinges mounted on support posts, and spaced by means of an air gap over underlying control circuitry. The control circuitry provides electrostatic forces, based at least in part on image data received from a controller (not explicitly shown).

The electrostatic forces cause each mirror to selectively tilt. Incident illumination light on the mirror array is reflected by the “on” mirrors along light path 114 for receipt by spatial light modulator 110 and is reflected by the “off” mirrors along off state light path 116 for receipt by a light dump (not explicitly shown). The pattern of “on” versus “off” mirrors (e.g., light and dark mirrors) modulates the light intensity reaching at least respective portions of spatial light modulator 110.

Spatial light modulator 110 generally refers to any device capable of producing an image 112 by selectively communicating light. In this particular embodiment, spatial light modulator 110 comprises a DMD substantially similar in structure to DMD 108; however any suitable spatial light modulator may be used. Further, the same or different spatial light modulators may be used for spatial light modulators 108 and 110. Thus, for example, a DMD may be used for spatial light modulator 110, while an LCD-based spatial light modulator is used for the spatial light modulator 108. Conversely, both spatial light modulators 108 and 110 may be DMDs or other similar types.

The order of light filtering, spatial integration, and intensity modulation of the illumination light beam, performed in the example embodiment by color wheel 104, integration rod 106, and spatial light modulator 108 respectively, is generally interchangeable, as illustrated in FIGS. 1A through 1F. For example, in some embodiments, spatial integration may occur after light intensity modulation In such embodiments, the spatial integration may be effected, for example, by alternatively positioning integration rod 106 (or by positioning an additional integration rod) within the light path 114 between spatial light modulators 108 and 110, as illustrated in FIG. 1B. In addition, intensity modulation may occur, for example, before light filtering. To illustrate, spatial light modulator 108 may be positioned, for example, within the light path between light source 102 and color wheel 104, as illustrated in FIG. 1C. Other embodiments may spatially integrate the light beam between light source 102 and color wheel 104, as illustrated in FIG. 1D. Some embodiments may spatially integrate and intensity modulate the illumination light beam before light filtering, as illustrated in FIGS. 1E and 1F. Various embodiments may spatially integrate the light beam provided by light source 112 at more than one of the stages or positions described above, or may not spatially integrate the light beam at all. Other suitable rearrangements or redundancy of components 104, 106, and 108 may be used without departing from the spirit of the present disclosure.

As shown in the example of FIG. 1A, video display system 100 only utilizes only two spatial light modulators 108 and 110. However, it should be recognized that the teachings of the present disclosure may also be applied to video display systems including additional spatial light modulators, as illustrated in FIGS. 1G and 1H.

FIG. 1G illustrates a block diagram of an alternative embodiment of a portion of the video display system 100 of FIG. 1A. As shown in FIG. 1G, a prism 118 may split the output from spatial light modulator 108 to multiple spatial light modulators 110a, 110b, and 110c, each spatial light modulator 110a, 110b, and 110c dedicated to a particular color.

FIG. 1H illustrates a block diagram of another alternative embodiment of a portion of the video display system 100 of FIG. 1A. As illustrated in FIG. 1H, the illumination light beam provided by light source 102 may separate into multiple colors after passing through a prism 118, each color directed toward respective spatial light modulators 108a, 108b, and 108c. In such embodiments, each spatial light modulator 108a, 108b, and 108c, may provide various attenuated light levels and intervals of its respective color to a respective imaging spatial light modulator 110.

Conventional methods of increasing bit-depth in video display systems are limited for a variety of reasons. For example, some systems add bit-depth by adding light-attenuating sections to a color wheel. However, the manufacture of such color wheels is often cost-prohibitive, each segment generally has only a single step of light reduction, and there generally is some level of light loss due to the additional interfaces between the added sections. Some other systems use light sources with a variable intensity output. However, such display systems generally have a limited number of possible light source amplitudes and some light loss due to the transition period between amplitude levels. In addition, such display systems are limited by spatial contouring artifacts and/or temporal artifacts due to dither noise. Similarly, some other systems using a mechanical shutter to reduce light output generally cannot transition between light attenuation levels fast enough to modulate single bits. In addition, such mechanical-shutter systems generally are limited in the number of light reduction steps and further limited by dither noise.

Accordingly, teachings of some embodiments of the present disclosure recognize that enhanced bit-depth and/or image contrast for video display systems 100 may be effected using one or more first spatial light modulators 108 to vary the illumination provided to one or more second spatial light modulators 110 dedicated to a visual display 112. In some embodiments, spatial light modulator 108 may be capable of switching speeds that may vary light intensity on a per bit segment basis. In such embodiments, the enhanced bit-depth may minimize or even eliminate dither noise limitations. Such embodiments may enable real-time image processing to determine the timing and percentage of light attenuation. The control electronics associated with spatial light modulators 108 may include a digital signal processor (“DSP”) and/or a general purpose microprocessor without having to include an ASIC. In some embodiments needing relatively few attenuation levels, a spatial light modulator 108 may be hardwired to provide a few discrete attenuation levels with minimal electronics. As explained further below, in some embodiments, spatial light modulators 108 may be chosen such that the light attenuation range is nearly the entire breadth of the light output, the attenuation steps are very fine, and the attenuation speed is very fast.

A better understanding of the DMDs utilized as spatial light modulators 108 and 110 may be had by referring to FIG. 2. FIG. 2 illustrates a DMD 200 which may be used in the video display system of FIG. 1. As shown in FIG. 2, DMD 200 comprises a microelectromechanical switching (“MEMS”) device that includes an array of hundreds of thousands of tilting micromirrors 204. In this example, each micromirror 204 is approximately 13.7 square microns in size and has an approximately one micron gap between adjacent micromirrors. In some examples, each micromirror can be less than thirteen square microns in size. In other examples, each micromirror can be approximately seventeen square microns in size. In addition, each micromirror 204 may tilt up to plus or minus ten degrees creating an active “on” state condition or an active “off” state condition. In other examples, each micromirror 204 may tilt, for example, plus or minus twelve degrees for the active “on” state or “off” state.

In this example, each micromirror 204 transitions between its active “on” and “off” states to selectively communicate at least a portion of an optical signal or light beam. To permit micromirrors 204 to tilt, each micromirror 204 is attached to one or more hinges 216 mounted on hinge posts 208, and spaced by means of an air gap over a complementary metal-oxide semiconductor (“CMOS”) substrate 202. In this example, micromirrors 204 tilt in the positive or negative direction until yoke 106 contacts conductive conduits 210. Although this example includes yoke 206, other examples may eliminate yoke 206. In those examples, micromirrors 204 tilt in the positive or negative direction until micromirrors 204 contact a mirror stop (not explicitly shown).

In this particular example, electrodes 212 and conductive conduits 210 are formed within a conductive layer 220 disposed outwardly from an oxide layer 203. Conductive layer 220 can comprise, for example, an aluminum alloy or other suitable conductive material. Oxide layer 203 operates to insolate CMOS substrate 202 from portions of electrodes 212 and conductive conduits 210. Conductive layer 220 receives a bias voltage that at least partially contributes to the creation of the electrostatic forces developed between electrodes 212, micromirrors 204, and/or yoke 206. That is, a bias voltage may be applied to conductive conduit 210 that propagates through hinge posts 208, along hinge 216 and through mirror via 218 to each micromirror 204. In particular embodiments, the latching bias voltage comprises a steady-state voltage. That is, the bias voltage applied to conductive conduit 216 remains substantially constant while micromirror 202 is in an “on-state” or “off-state” position. In this example, the latching bias voltage comprises approximately twenty-six volts. Although this example uses a bias voltage of twenty-six volts, other latching bias voltages may be used without departing from the scope of the present disclosure.

In this particular example, CMOS substrate 202 comprises the control circuitry associated with DMD 200. The control circuitry can comprise any hardware, software, firmware, or combination thereof capable of at least partially contributing to the creation of the electrostatic forces between electrodes 212, micromirrors 204, and/or yoke 206. The control circuitry associated with CMOS substrate 102 functions to selectively transition micromirrors 204 between “on” state and “off” state based at least in part on data received from a controller (not explicitly shown).

In this particular example, micromirror 204a is positioned in the active “on” state condition, while micromirror 204b is positioned in the active “off” state condition. The control circuitry transitions micromirrors 204 between “on” and “off” states by selectively applying a control voltage to at least one of the electrodes 212 associated with a particular micromirror 204. For example, in general, to transition micromirror 204b to the active “on” state condition, the control circuitry removes the control voltage from electrode 212a and applies the control voltage to electrode 212b. In this example, the control voltage comprises approximately three volts. Although this example uses a control voltage of approximately three volts, other control voltages may be used without departing from the scope of the present disclosure.

Generally, there is a response time associated with the movements of micromirrors 204 between the “on” state and the “off” state. It takes an interval of time, called the mirror flight time, for the mirror to assume the new position. In particular embodiments, this mirror flight time limits the minimum on-time of each micromirror 204 to approximately 16 μs. For conventional DMD display systems, this 16 μs minimum on-time results in a maximum bit-depth of 8 bits.

Referring back to FIG. 1, the video display system 100 attempts to overcome this 16 is minimum on-time limitation by varying the light intensity provided to spatial light modulator 110 and applying the lower significant bits during the attenuated light interval. Particular embodiments of the present disclosure accomplish this attenuated light interval by reducing the light intensity provided to spatial light modulator 108 using spatial light modulator 110. A PWM sequence is then used to cause imaging spatial light modulator 110 to display lower significant bits during the attenuated light interval, so that the attenuated light interval and the lower significant bits are synchronized. As a result, the effective display levels of those lower significant bits are smaller, thus, achieving greater bit depth.

Generally, the particular light intensity reduction by spatial light modulator 108 will determine the possible increase in bit-depth. In particular embodiments utilizing DMD 108, this intensity may be reduced by briefly increasing the number of “off” pixels associated with DMD 108. For example, if DMD 108 reduces the light intensity along light path 114 to 25% of its peak intensity, then two more bits of bit-depth may be achieved in the case of binary bits, increasing bit-depth from 8 bits to 10 bits in this example. In particular embodiments of the present disclosure, this may be implemented by having two 25% attenuated light intervals per frame of each color. The shortest bit applied would have an on-time of 16 μs. The use of the attenuated light would then give an effective bit on-time of 4 μs, corresponding to a 10-bit LSB. During the next attenuated light interval in the frame, a bit on-time of 32 μs could be shown, giving an effective bit on-time 8 μs. In total, when using the binary bit weights, the result is as follows.

| Bit | Light Levels | Effective Bit On-Time (μs) |
|---|---|---|
| B9 | 512 | 2048 |
| B8 | 256 | 1024 |
| B7 | 128 | 512 |
| B6 | 64 | 256 |
| B5 | 32 | 128 |
| B4 | 16 | 64 |
| B3 | 8 | 32 |
| B2 | 4 | 16 |
| B1 | 2 | 8 (32 μs during 25% low pulse) |
| B0 | 1 | 4 (16 μs during 25% low pulse |

In this example, all bit weights are binary. However, particular embodiments of the present disclosure may utilize non-binary bit weights. Furthermore, LSBs created during the attenuated light interval may also be non-binary. The embodiment discussed above describes example bit-depth effects using DMD 108 to attenuate the light provided to DMD 110 to 25% of its peak intensity. However, spatial light modulators such as DMD 108, may vary the light intensity provided to spatial light modulators such as DMD 110 by other amounts within the teachings of the present disclosure. For example, in one embodiment DMD 108 may reduce the light intensity provided to DMD 110 by, for example, 93.75%, 75%, 50%, 25%, or 12.5% of its peak intensity. Furthermore, particular embodiments of the present disclosure could vary the level of reduction in the light intensity during a single frame. For example, the first attenuated light interval in a frame could be 25% of the peak light intensity, while the second attenuated light interval of the frame could be 50% of the peak light intensity. Many other possibilities exist for the attenuated light percentage and PWM bit timing used in accordance with the teachings of the present disclosure. Furthermore, the width and shape of the attenuated light interval may also take many forms depending on the desired implementation, all falling within the teachings of the present disclosure. Spatial light modulation patterns associated with these generalized example embodiments are illustrated in FIGS. 3A-3J.

FIGS. 3A-3J illustrate example spatial patterns 300 that may be used by the spatial light modulator 108 of FIG. 1 to modulate the light intensity provided to spatial light modulator 110. In the illustrated embodiments, each individual square represents a pixel element in an array that is operable to switch between on and off states, represented by light and dark pixel elements respectively. In general, the light attenuation by spatial light modulator 108 is a function of the ratio of “on” pixels to the “off” pixels. Although the spatial patterns illustrated in FIGS. 3A-3J show a four-by-four array including sixteen pixel elements, it will be appreciated that the same general teachings apply to any appropriate array. For example, these general teachings may apply to various shapes of arrays including hundreds of thousands or even millions of pixel elements.

As shown in FIGS. 3A-3E, the spatial patterns 300 may reduce light intensity in an aperture-like fashion. That is, each pattern 300 includes a set of “on” pixels 302 generally bordered by a set of “off” pixels 304. In various embodiments, such patterns 300 may enhance the contrast ratio in low light conditions. FIGS. 3A, 3B, 3C, 3D, and 3E illustrate example spatial patterns 300 that may be used to reduce the light intensity provided to DMD 110 by 93.75%, 75%, 50%, 25%, or 12.5% respectively.

As shown in FIGS. 3F-3J, the spatial patterns 300 may evenly attenuate light intensity across the surface of spatial light modulator 108. That is, the “on” and “off” pixels of each pattern 300 are evenly distributed in a checkerboard-like fashion. FIGS. 3F, 3G, 3H, 3I, and 3J illustrate example spatial patterns 300 that may be used to reduce the light intensity provided to DMD 110 by 93.75%, 75%, 50%, 25%, or 12.5% respectively.

Referring back to FIG. 1, as previously mentioned, various alternative embodiments may position integration rod 106 within light path 114 between spatial light modulators 108 and 110. In such embodiments, integration rod 106 may spatially integrate the output from spatial light modulator 108, thereby evenly distributing the light intensity modulation irrespective of the particular spatial pattern 300. Some embodiments may include alternative or additional optical components disposed within the light path 114 between spatial light modulators 108 and 110. These components may include, for example, lenses operable to direct the intensity modulated light beam to spatial light modulator 110.

The teachings of the present disclosure recognize, however, that varying illumination intensity without spatially integrating the illumination output from spatial light modulator 108 may enable spatial light attenuation. Thus, with proper alignment, the illumination provided to imaging spatial light modulator 110 may be applied on a per-pixel or per-pixel-region basis.

In still other embodiments, spatial light modulator 108 may alternatively be synchronized with a particular image or scene content irrespective of a particular bit segment. For example, in such embodiments, spatial light modulator 108 may use patterns 300 to provide plural light intensity levels to the surface of spatial light modulator 110, the darker levels coinciding with a darker portion of the image or scene. In some such embodiments, the attenuation may be effected on a regional basis, for example, using one or more inverse-aperture patterns that are each the digital opposite of one of the example patterns illustrated in FIGS. 3A-3E. Alternatively, the attenuation may affect the light provided to spatial light modulator 110 globally.

FIG. 4 is a chart 400 of light intensity versus time applied to a several bit-planes 402, 404, 406, and 408 of a portion of the spatial light modulator 110 of FIG. 1 according to one example embodiment of the present disclosure. As illustrated in FIG. 4, the visible brightness of a particular bit-plane 402, 404, 406, and 408 is a function of its area. Bit-planes zero 402, one 406, two 404, and three 408 span the time intervals from t1 to t2, t2 to t3, t3 to t4, and t4 to t5 respectively. The efficient switching speeds of various spatial light modulators 108 may enable nearly square light level transitions between time intervals (e.g., between time intervals t1 and t2).

In this particular embodiment, bit-plane zero 402 has a minimum duration of 18 μs, from t1 to t2. At the instant of resetting bit-plane zero 402, or at t1, spatial light modulator 108 may provide, for example, only 7.5% of its received light to spatial light modulator 110. At the end of bit-plane zero 402, or at t2, spatial light modulator 108 may then provide, for example, 100% of its received light to spatial light modulator 110. Thus, bit-plane zero 402, in the illustrated example, has an “effective duration” of 1.35 μs, or the equivalent amount of time necessary to produce the same visible brightness at 100% illumination. This illustrated bit-depth increase modifies a real eight-bit system to enable twelve-bit applications.

Thus, by decreasing the light intensity provided to spatial light modulator 110 by spatial light modulator 108, and displaying lower significance, or “short,” bits during the attenuated light interval, particular embodiments of the present disclosure offer the ability to increase the bit-depth of a spatial light modulator-based video display system despite the timing limitations typical of some spatial light modulators.

Although particular embodiments of the method and apparatus of the present disclosure have been illustrated in the accompanying drawings and described in the foregoing detailed description, it will be understood that the disclosure is not limited to the embodiments disclosed, but is capable of numerous rearrangements, modifications, and substitutions without departing from the spirit of the disclosure as set forth and defined by the following claims.

What is claimed is:

1. A method for increasing the bit-depth of a video display system, comprising intensity modulating, by a first deformable micromirror device, illumination provided to at least a portion of a second deformable micromirror device.

2. A display system, comprising:
one or more first spatial light modulators;
a light source operable to generate a light beam for use in illuminating each first spatial light modulator;
a processor operable to provide a signal indicating that illumination provided to at least a portion of each one or more first spatial light modulators should be modified; and
one or more second spatial light modulators operable to modify the illumination provided to at least a portion of at least respective ones of the one or more first spatial light modulators in response to the signal, by modulating the light beam.

3. The system of claim 2, wherein each first spatial light modulator and second spatial light modulator are selected from the group consisting of:
a deformable micromirror device;
a liquid crystal device;
a liquid crystal on silicon device;
an interferometic modulator;
an analog MEMS device; and
an acoustooptic cell.

4. The system of claim 2, wherein each second spatial light modulator is operable to modify the illumination provided to the at least a portion of at least respective ones of the one or more first spatial light modulators by selectively communicating portions of the illumination received from the light source.

5. The system of claim 2, wherein each of the second spatial light modulators are further operable to modify, from a first level to a second level during a first time period, the illumination provided to at least a portion of at least respective ones of the one or more first spatial light modulators.

6. The system of claim 5, wherein the illumination at the second level is from about 0.25% to about 94% of the illumination at the first level.

7. The method of claim 5, wherein the first time period is a function of the length of time corresponding to a display bit segment of respective ones of the one or more first spatial light modulators.

8. The system of claim 5, wherein the first time period is a function of the length of time a particular color of light illuminates respective ones of the one or more first spatial light modulators.

9. The system of claim 6, wherein the first time period is between 18 microseconds and 1 millisecond.

10. The system of claim 2, and further comprising a light-integration rod operable to spatially integrate the illumination provided to the one or more first spatial light modulators.

11. A method for increasing the bit-depth of a display system, comprising:
illuminating one or more first spatial light modulators;
receiving a signal indicating the illumination provided to at least a portion of at least one of the one or more first spatial light modulators should be modified; and
intensity-modulating, by one or more second spatial light modulators in response to the signal, the illumination provided to at least a portion of the at least one of the one or more first spatial light modulators.

12. The method of claim 11, wherein each first spatial light modulator and second spatial light modulator are selected from the group consisting of:
a deformable micromirror device;
a liquid crystal device;
a liquid crystal on silicon device;
an interferometic modulator;
an analog MEMS device; and
an acoustooptic cell.

13. The method of claim 11, wherein intensity-modulating further comprises selectively communicating at least a portion of the illumination by the one or more second spatial light modulators.

14. The method of claim 11, wherein intensity-modulating further comprises intensity-modulating from about a first level to about a second level during a first time period.

15. The method of claim 14, wherein the illumination at the second level is from about 0.25% to about 94% of the illumination at the first level.

16. The method of claim 14, wherein the first time period is a function of the length of time corresponding to a display bit segment of respective ones of the one or more first spatial light modulators.

17. The method of claim 14, wherein the first time period is a function of the length of time a particular color of light illuminates respective ones of the one or more first spatial light modulators.

18. The method of claim 14, wherein the first time period is between 18 microseconds and 1 millisecond.

19. The method of claim 11, and further comprising spatially integrating the illumination provided to the one or more first spatial light modulators.

20. The method of claim 11, and further comprising spatially integrating the illumination provided to the one or more second spatial light modulators.

21. The method of claim 13, and further comprising selectively communicating at least a portion of the illumination using one or more illumination patterns, each pattern comprising an arrangement of on pixels and off pixels.

22. The method of claim 21, wherein the intensity of the illumination provided to at least a portion of the at least one of the one or more first spatial light modulators is a function of a ratio of the on pixels to the off pixels.

23. The method of claim 21, and further comprising spatially modulating the illumination provided to the one or more first spatial light modulators to display an image having one or more brighter spatial regions and one or more darker spatial regions; and
wherein the on pixels and the off pixels substantially spatially correspond respectively to the one or more brighter spatial regions and the one or more darker spatial regions of the image.

24. The method of claim 21, and further comprising spatially modulating the illumination provided to the one or more first spatial light modulators to display an image having a plurality of display pixels; and
wherein each of the on pixels and each of the off pixels correspond to respective ones of the display pixels.

25. The method of claim 21, wherein the one or more illumination patterns are predetermined; and
further comprising switching between the one or more predetermined illumination patterns in response to respective predetermined configurations of the signal.

26. The method of claim 21, wherein the arrangement of on and off pixels of each pattern comprises a shape selected from the group consisted of:
substantially aperture-like; and
substantially checkerboard-like.
